(19) United States
(12) Patent Application Publication
(10) Pub. No.: US 2010/0205568 A1
(43) Pub. Date: Aug. 12, 2010

(54) GRAPHICAL USER INTERFACE

(76) Inventors: Dale Edward Mooney, Auckland (NZ); Alex Lavrinovich, Auckland (NZ); Jason Brett Mobberley, Auckland (NZ)

Correspondence Address: GREER, BURNS & CRAIN, 300 S WACKER DR, 25TH FLOOR, CHICAGO, IL, 60606, US

(21) Appl. No.: 12/444,978

(22) PCT Filed: Oct. 13, 2006
(86) PCT No.: PCT/NZ06/00264

§ 371 Date: Apr. 19, 2010

(51) Int. Cl. G06F 3/048

(52) U.S. Cl. 715/849

(57) ABSTRACT

This invention provides a graphical user interface which receives a 3-dimensional representation of a first object, provides controls to specify a second object and displays a 3-dimensional representation of the first object in conjunction with the second object. The first object may be a hand of a person and the second object may be a jewellery ring to be made from the specification.

### TECHNICAL FIELD

The present invention relates to a graphical user interface. In particular, the invention relates to an interface which provides graphical representations of goods. Preferably the present invention may provide a graphical interface which provides 3-dimensional representations of goods. In specific embodiments the invention may provide a graphical user interface which provides 3-dimensional graphical representations of rings in association with 3-dimensional graphical representations of a given hand.

### BACKGROUND ART

The applicant has observed that 3-dimensional digital representations might be useful in applications involving the retailing of goods. One particular application which has occurred to the applicant is the retailing of jewellery, rings and gems. The applicant has discovered that some customers in the market for an item of jewellery often have difficulty in visualising how an item which they see in a shop display (for example), will look on their person. In the case of a ring, the thickness of a band may sometimes have a surprising impact on the overall appearance of their fingers when a given ring is placed on their own hand. For this reason, retailers attempt to carry as many different sizes and types of band setting and gem as possible. However, this carries an economic cost in the form of additional inventory.

It has occurred to the applicant that displaying a 3-dimensional representation of a customer's hand combined with a 3-dimensional representation of a jewellery ring may assist customers of jewellery rings in making better choices or may allow retailers to carry less inventory.

The applicant has also observed that if a ring is chosen based on a 3-dimensional representation there is considerable flexibility in the choice of components that might be specified for the ring.

Accordingly, it is a further object of the present invention to provide a graphical user interface that facilitates creating of a specification of an object, or at least to provide the public with a useful choice in graphical user interfaces.

It is a further object of the present invention to provide a graphical user interface that allows a specified object to be represented in conjunction with another object, or at least to provide the public with a useful choice in graphical user interfaces.

It is an object of the present invention to address the foregoing problems or at least to provide the public with a useful choice.

As used herein the term ‘degrees of zoom’ or suchlike refers to how large a representation of an object appears in a given display.

As used herein the term ‘textual representation’ and suchlike is intended to broadly refer to a representation of characteristics by any text, lettering, wording or other symbols.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

An aspect of the present invention comprises a set of computer executable instructions stored on a computer readable medium, said instructions adapted to carry out a method including the steps of:
I. receiving a 3-dimensional representation of a first object;
II. providing a set of controls adapted to allow selections which specify characteristics of a second object to be made;
III. receiving through said set of controls indications of events identifying said selections;
IV. generating a 3-dimensional representation of the first object combined with the second object; and
V. providing a display of said 3-dimensional representation of the first object combined with the second object.

This invention allows a customer or operator to make selections which specify characteristics of the second object and to make those selections in light of a displayed representation of that object in combination with another object. This facilitates visualization of the object being specified in combination with a first object with which it will be used or worn. This allows better selections to be made in relation to the specified characteristics of the second object.

Preferably, said generating the 3-dimensional representation of the first object combined with the second object preserves the geometry of the first and second objects.

Preferably, the method includes updating the generated 3-dimensional representation after given events identifying selections made with the controls.

Preferably, the generated 3-dimensional representation includes a geometrical mesh representation comprising mesh elements.

Preferably, mesh elements corresponding to the first object include photographic representations of parts of the first object.

Preferably, said photographic representations are displayed using at least 3 colours.

Preferably, said selections specify characteristics by selecting given components for the second object.

Preferably, said selections specify materials for the second object.

Preferably, said selections specify dimensions for the second object.

Preferably, the controls are adapted to allow a user to adjust the dimensions of the second object.

Preferably, said generated 3-dimensional representation of the first object combined with the second object includes a representation of a given interrelationship between the first and second objects.

Preferably, the second object is a ring.

Preferably, the first object is a hand.

Preferably, said representation of the given interrelationship is the ring shown fitted onto a finger of the hand.

Preferably, said 3-dimensional representation of a hand combined with a ring shows a ring of a given diameter.

Preferably, the method includes providing controls adapted to allow adjustment of a position of the ring on the finger.

Preferably, said 3-dimensional representation of the hand in conjunction with a ring shows a ring of a given band width.

Preferably, the method includes providing a user control adapted to allow adjustment of the width of a band as it appears on the generated 3-dimensional representation.

Preferably, the generated 3-dimensional representation of the first object combined with the second object is displayed from a given view point.

Preferably, the method includes providing controls adapted to allow said given view point to be reoriented.

Preferably, the generated 3-dimensional representation of the hand in conjunction with a ring is displayed with a given degree of zoom.

Preferably, the method includes providing controls to allow said given degree of zoom to be adjusted.

Preferably, the method includes capturing and storing 2-dimensional displays of said generated 3-dimensional representation of a hand in conjunction with the ring at given view points and degrees of zoom.

Preferably, wherein generating said 3-dimensional representation includes retrieving stored 3-dimensional representations of jewellery ring components.

Preferably, wherein the generated 3-dimensional representation of the hand combined with the ring includes at least one colour assigned to the ring band.

Preferably, the method includes providing a user control adapted to allow the selection of at least one colour assigned to the ring.

Preferably, said control adapted to allow the selection of at least one colour including a textual description of at least one metal.

Preferably, at least one colour assigned to the ring corresponds to at least one metal represented by the control.

Preferably, the method includes displaying a numerical value representing a calculated cost of the ring specified by the selections and/or adjustments.

Preferably, the method includes generating a report, said report, including details specifying any selections and/or adjustments made with said user controls.

Preferably, said report also includes a captured 2-dimensional image of the 3-dimensional representation.

Preferably, wherein the report includes a monetary value calculated with reference to the given specification.

Preferably, wherein the report includes details identifying the person associated with the first object.

Preferably, wherein the user controls are adapted to allow selection of styles of jewellery ring band.

Preferably, the user control is adapted to allow selection of styles of jewellery ring gem setting.

Preferably, the user control is adapted to allow selection of at least one gem for said setting.

Preferably, the user control is adapted to allow selection of gems to be set into the band.

Preferably, the user control is adapted to allow selection of styles of jewellery ring band.

Preferably, the method includes providing a user control adapted to allow the selection of given cuts of gem.

Preferably, the method includes a control adapted to allow the selection of classifications of gems.

Preferably, the generated 3-dimensional representation includes a representation of at least one gem of a given colour.

Preferably, the method includes providing a control adapted to allow a selection of the colour of the at least one gem.

Preferably, the control provides a textual representation of a gem represented by each colour.

Preferably, the generated 3-dimensional representation includes a representation of a gem of a given size.

Preferably, the generated 3-dimensional representation includes a gem of a given cut.

Preferably, wherein the method includes providing a control adapted to allow the selection of a weight for at least one gem.

Preferably, wherein the method includes providing controls adapted to receive contact details of a person associated with the hand.

Preferably, wherein the method includes providing on a screen a combination of controls adapted to:
receive contact information for a person associated with the hand;
allow the selection of a given finger of the hand; and
allow the selection of a ring size.

Preferably, wherein the method includes providing a control adapted to initiate an apparatus to capture 3-dimensional representation of an object.

### BRIEF DESCRIPTION OF DRAWINGS

Further aspects of the present invention will become apparent from the ensuing description which is given by way of example only and with reference to the accompanying drawings in which:

FIG. 1 depicts processes carried out by a graphical user interface according to a preferred embodiment of the present invention;

FIG. 2 shows a first screen presented by a graphical user interface according to the preferred embodiment of the present invention;

FIG. 3 depicts information needed to specify a ring and produce a final report (shown later) according to the preferred embodiment of the present invention;

FIG. 4 shows another screen presented by a graphical user interface according to the preferred embodiment of the present invention, this screen relating to an indication that a 3-dimensional representation has been captured;

FIG. 5 shows a screen presented by a graphical user interface displaying controls which allow a ring to be specified according to the preferred embodiment of the present invention;

FIG. 6 shows a screen presented by a graphical user interface displaying controls which allow a ring to be specified according to the preferred embodiment of the present invention;

FIG. 7 shows a screen presented by a graphical user interface displaying controls which allow a ring to be specified according to the preferred embodiment of the present invention;

FIG. 8 shows a screen presented by a graphical user interface displaying controls which allow a ring to be specified according to the preferred embodiment of the present invention;

FIG. 9 shows a screen presented by a graphical user interface displaying controls which allow a ring to be specified according to the preferred embodiment of the present invention;

FIG. 10 shows a screen presented by a graphical user interface displaying controls which allow a ring to be specified according to the preferred embodiment of the present invention;

FIG. 11 shows a screen presented by a graphical user interface displaying controls which allow a ring to be specified according to the preferred embodiment of the present invention;

FIG. 12 shows a screen presented by a graphical user interface displaying controls which allow a ring to be specified according to the preferred embodiment of the present invention;

FIG. 13 shows a screen presented by a graphical user interface displaying controls which allow a ring to be specified according to the preferred embodiment of the present invention;

FIG. 14 shows a screen presented by a graphical user interface displaying controls which allow a ring to be specified according to the preferred embodiment of the present invention;

FIG. 15 shows a final report presented by a graphical user interface according to the preferred embodiment of the present invention;

FIG. 16 depicts an overview of a method carried out by the preferred embodiment of the present invention.

### BEST MODES FOR CARRYING OUT THE INVENTION

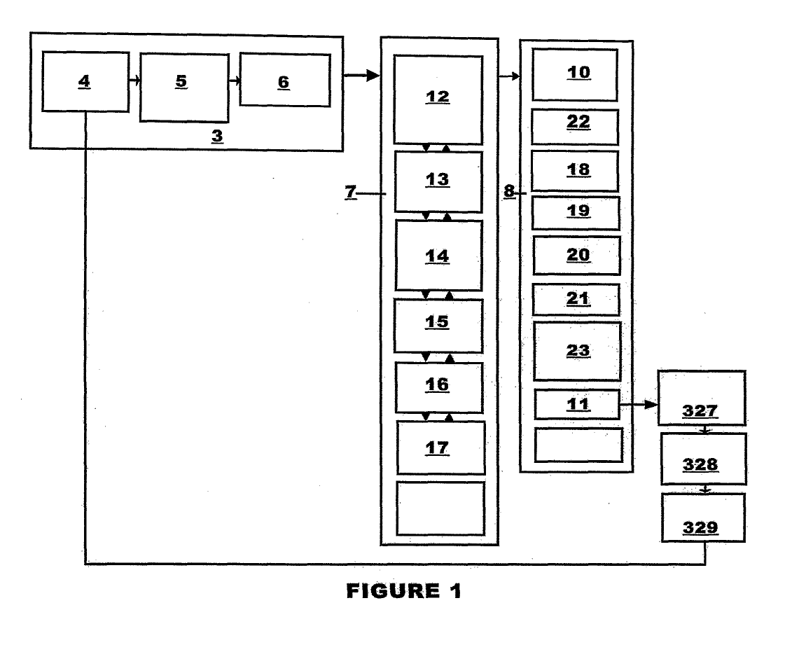

FIG. 1 depicts a process carried out by a Graphical User Interface (GUI) according to a preferred embodiment of the present invention.

The graphical user interface is described below in reference to use in specifying and displaying jewellery rings. The jewellery rings are displayed on a 3-dimensional representation of the customer's hand with the specified ring to allow them to make informed choices on aesthetic aspects of the jewellery ring (not shown). It will be apparent to those skilled in the art that alternative embodiments may be readily adapted for use in displaying a variety of other retail goods.

FIG. 1 depicts an event driven process so it will be appreciated by those skilled in the art that the order of different processes depicted in the diagram is not necessarily sequential.

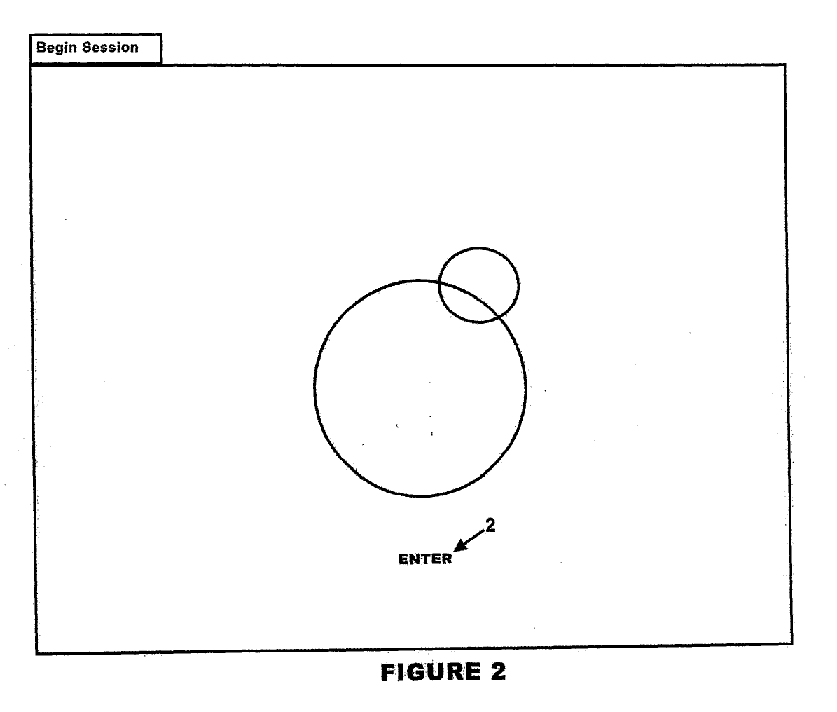

The process begins with an initialisation sequence (3). A button (2) is displayed on a screen, shown in FIG. 2. When the button is clicked, at step 4, a GUI operator is prompted for initialisation information, step 5. This information includes contact information for the customer, the choice of the finger on which the ring is to be displayed, and the size of that finger.

At step 6 the GUI activates a scanning apparatus (not shown), waits for it to provide data and then receives that data. The data defines a captured 3-dimensional representation of the customer's hand. When this 3-dimensional representation is received, still at step (6), the initialisation sequence (3) is completed.

In the preferred embodiment, the GUI is used in conjunction with a scanning apparatus which provides a geometrical mesh. The geometrical mesh has mesh elements which are ‘painted’ with photographic representations of corresponding portions of the hand. The 3-dimensional representation of the hand therefore is geometrically accurate to the eye and also shows the texture and colouring of the customer's hand.

At the end of the initialisation sequence the GUI has a geometrically accurate and photographically accurate representation of a given hand has contact details of the person associated with the hand. The GUI also has a designated finger of the hand on which a jewellery ring is to be worn. At this stage the GUI also has the size of that finger.

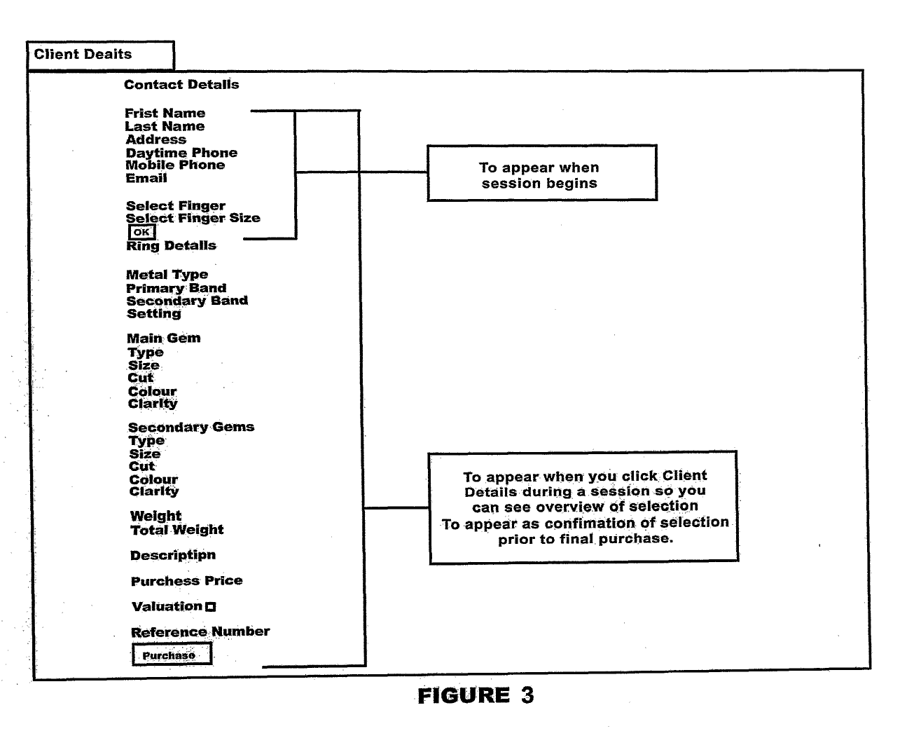

FIG. 3, at the top of the page, depicts the details for which prompts are provided in step 5.

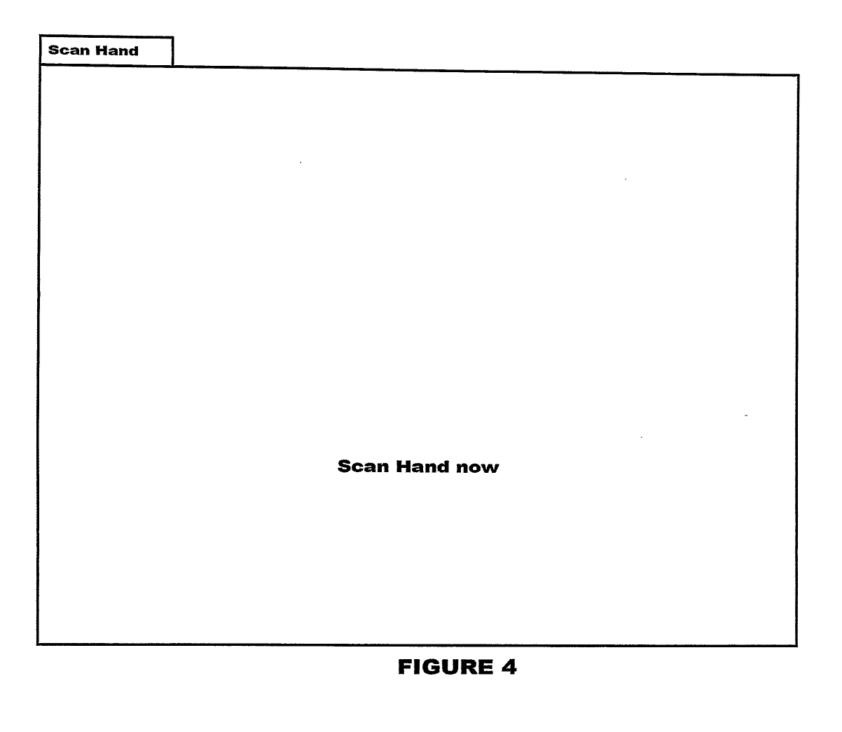

FIG. 4 shows a typical screen which might be displayed in step 6 while an apparatus (not shown) is capturing and providing a 3-dimensional representation of a given hand.

Referring again to FIG. 1, box 7 depicts a set of selection processes available to the operator and the customer once the initialisation sequence (3) has been completed. These processes allow an operator to specify comments, shapes, and materials to provide a specification for the ring which is eventually to be made for the customer. The various aspects which must be specified for a ring or alternative goods will be apparent to those skilled in the art.

Box 7 depicts selection, or specification processes which are enabled once the initialisation sequence (3) has been completed.

The selection processes (7) are represented by GUI controls displayed concurrently with a display of the ring on the hand. This display is provided by the display process (8). The display of the ring on the hand is shown concurrently with controls unless a GUI control process (9) is activated, by button (118), to close the selection process (7). The GUI controls associated with the selection process (7) can be made visible again by activation of a ‘select’ GUI control process represented by box (10).

The display processes (8) also provide a purchase GUI control depicted by box 11 which initiates an accounts sequence.

One of the selection processes (7) is a ‘ring type’ process (6) which allows selection of various types of ring.

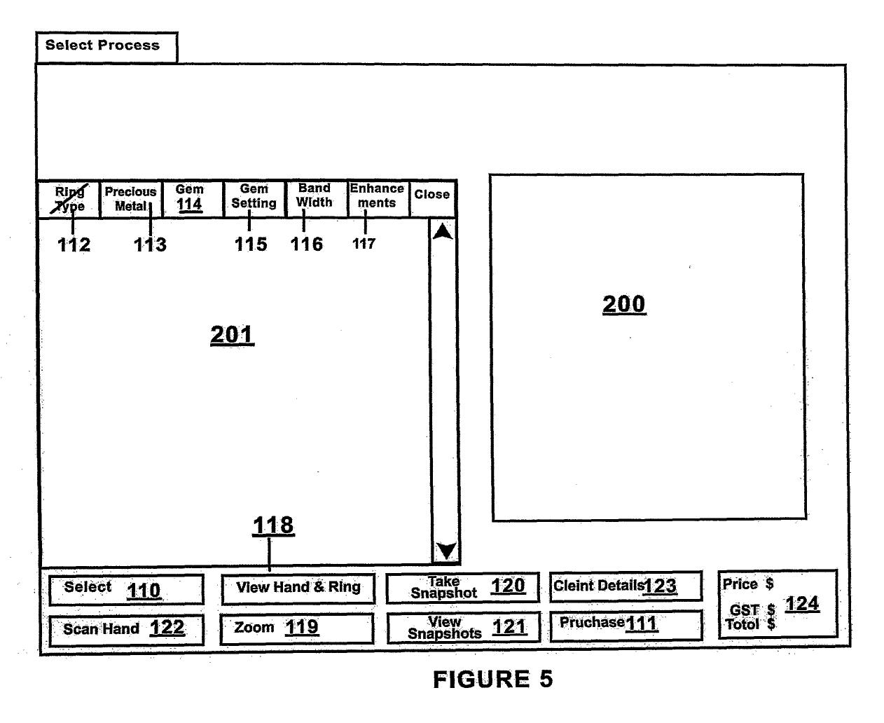

FIG. 5 shows a GUI screen (1) displayed immediately after the initialisation sequence is completed. The screen has a display pane (200) in which a 3-dimensional representation of a customer's hand is displayed.

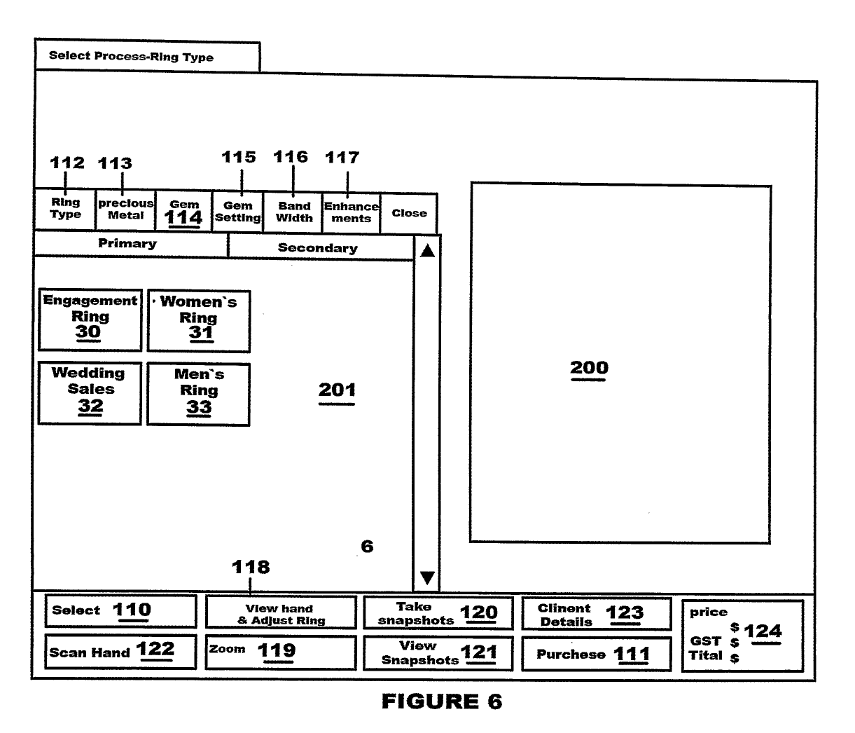

FIG. 6 shows a GUI screen (1) which is presented when the button (112) is activated. This activates the ‘ring type’ processes of box (12), FIG. 1. Activating the ring type button updates the pane (201) with additional buttons (30 to 33). Each button (30 to 33) represent a different type of ring. In the preferred embodiment the rings displayed are engagement rings (30), women's rings (31), wedding sets (32) and men's rings (33).

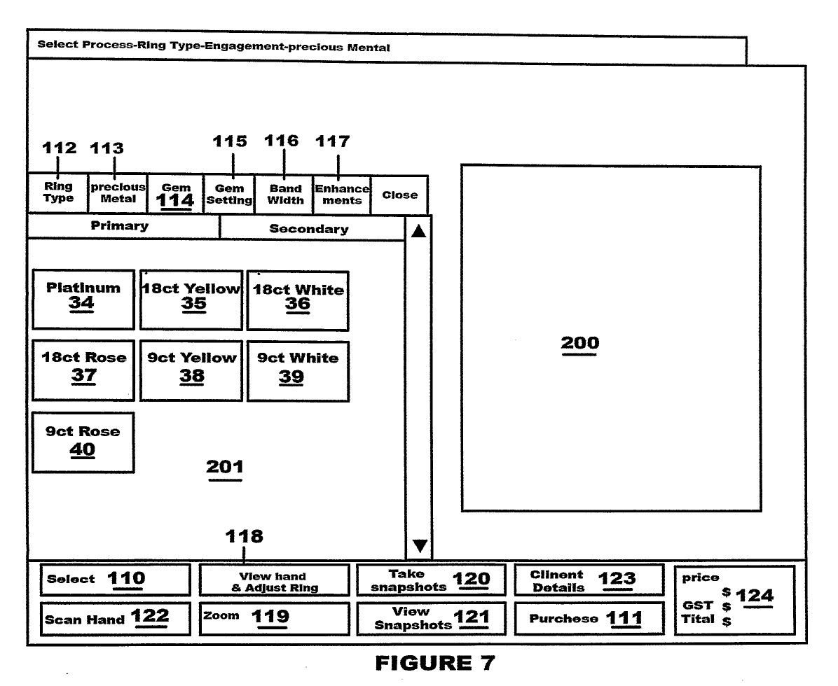

FIG. 7 depicts the GUI screen (1) after the ‘precious metals’ button (113) is activated. This activates the ‘precious metals’ processes represented by box (13) of FIG. 1.

The buttons relating to different metals which a customer may choose for the ring are 18 carat white gold (36), 18 carat rose gold (37), 9 carat yellow gold (38), 9 carat white gold (39) and 9 carat rose gold (40).

Activation of any of the buttons (30) initiate the generation of a 3-dimensional representation of the user's hand with a jewellery ring (not shown) specified by the selections made by activating given buttons (30) to (40). The jewellery ring will be displayed on the finger designated in step 5 and will be sized according to the finger size depicted in step 5.

Referring to FIG. 6 a box 200 depicts a GUI pane in which the 3-dimensional representation will be displayed. It will be apparent to those skilled in the art that a 3-dimensional representation may be displayed in the form of 2-dimensional representations which can be updated. In the preferred embodiment, the 3-dimensional representation takes the form of a display of a hand with a ring which can be manipulated to re-orientate it with respect to the view seen through the pane (200). GUI controls depicted by processes (18 to 21) and buttons (118 to 121) allow the operator to adjust the view of the generated 3-dimensional representation of the hand in conjunction with the ring shown on the hand.

The process (18), activated by button (118), activates controls which allow the hand to be viewed and the ring to be adjusted.

The processes (19) activated by button (119) allow the view to be zoomed in or out to various degrees.

The processes (20), activated by button (120), takes snap shots of the generated 3-dimensional representation of the hand in conjunction with the ring from given view points and ‘degrees of zoom’.

In the process (10), represented by the button (110), is always visible and toggles between the selection process pane (201) with buttons (112 to 117), being visible or hidden.

The scan hand process (22), represented by the button (122), allows the GUI to initiate a repeated 3-dimensional scanning process from which a new 3-dimensional representation of the customer's hand can be received by the GUI.

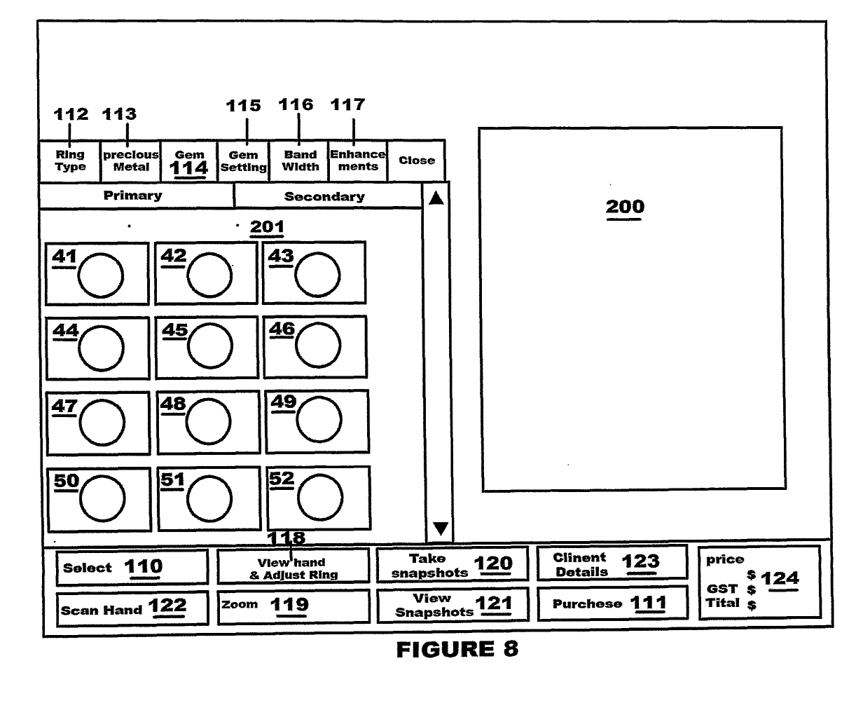

FIG. 8 depicts a GUI screen represented when the button (113) is activated and then one of the buttons (30 to 33) is activated. The buttons (41 to 52) represent various designs of jewellery ring band which might be selected by activation of these buttons. The buttons (41 to 52) may show pictorial representations of the jewellery ring bands.

Referring to FIG. 8 the process (23) represented by the button (123) provides a display (not shown) of the customer's details taken at step 5.

Referring to FIG. 8 the button (111) activates the purchase process (11) which in turn activates an accounts process.

The price process (24) represented by the display field (124) provides a price that has been calculated by the GUI for the jewellery ring as defined by selections made by the selection processes (7). In the preferred embodiment, the price shown in box (124) represents the cost of the goods to a customer. This cost has been generated by the storing the selections made by the selection processes (7) and are calculated in reference to a database of materials and costs (not shown).

Also in the preferred embodiment, the costs are updated each time a new selection is made by one of the selection processes (7).

The GUI screen (1) also has a pane (201) in which GUI controls are provided. The controls shown in FIG. 5 are a set of buttons (112 to 117) which initiate the various selection processes (12 to 17), depicted in FIG. 1.

The display of the generated 3-dimensional representation of the hand in conjunction with a jewellery ring as shown in pane 200 is updated with each selection made via the selection processes (7). For example, selection of a new type of jewellery band by all of the buttons (41 to 52) will result in the display shown in pane 200 updating to represent the newly selected jewellery ring band.

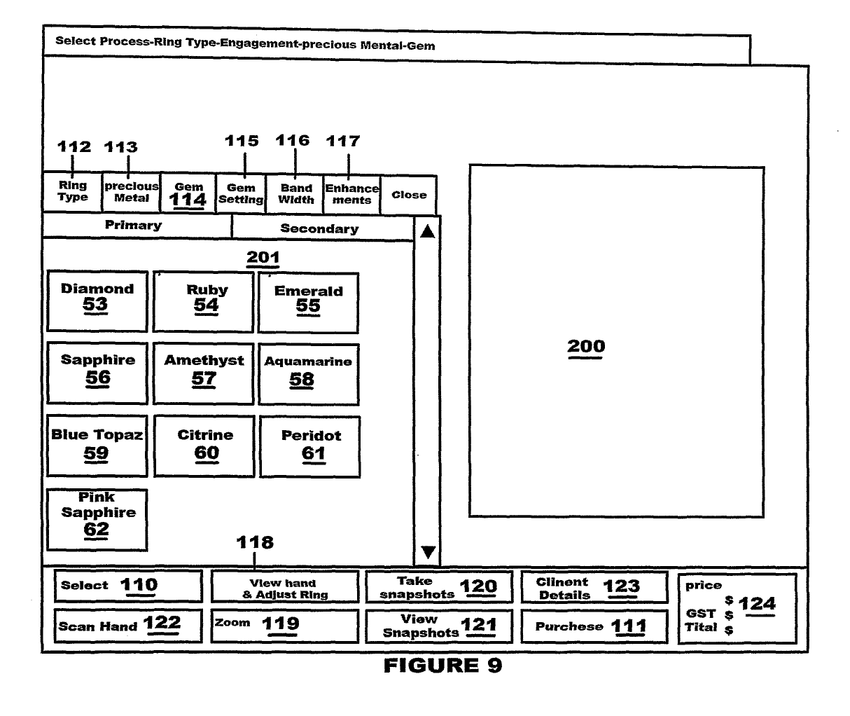

FIG. 9 depicts GUI screen displayed to allow the selection of different types of gem by the activation of boxes (53 to 62). The pane (201) is updated with the set of boxes (53 to 62) by activation of the box (115).

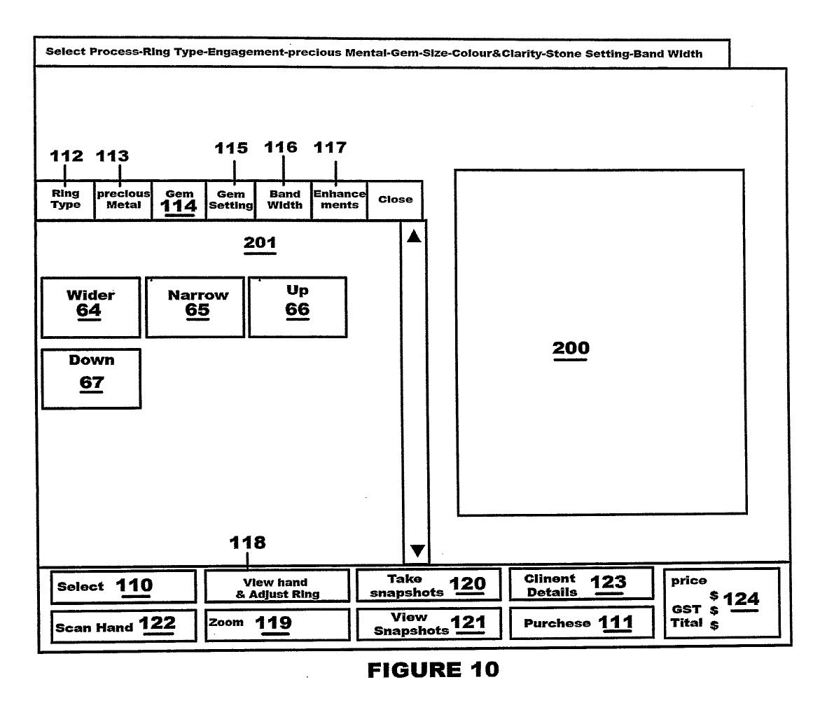

FIG. 10 depicts the GUI screen in which the pane (201) has been updated with boxes (64 to 67) by activation of the button (117). Buttons (64) and (65) allow the width of the jewellery band to be increased or decreased respectively. Also shown in pane (201) are buttons (66) and (67) which allow the operator to adjust the position of the ring upwards or downwards on the finger.

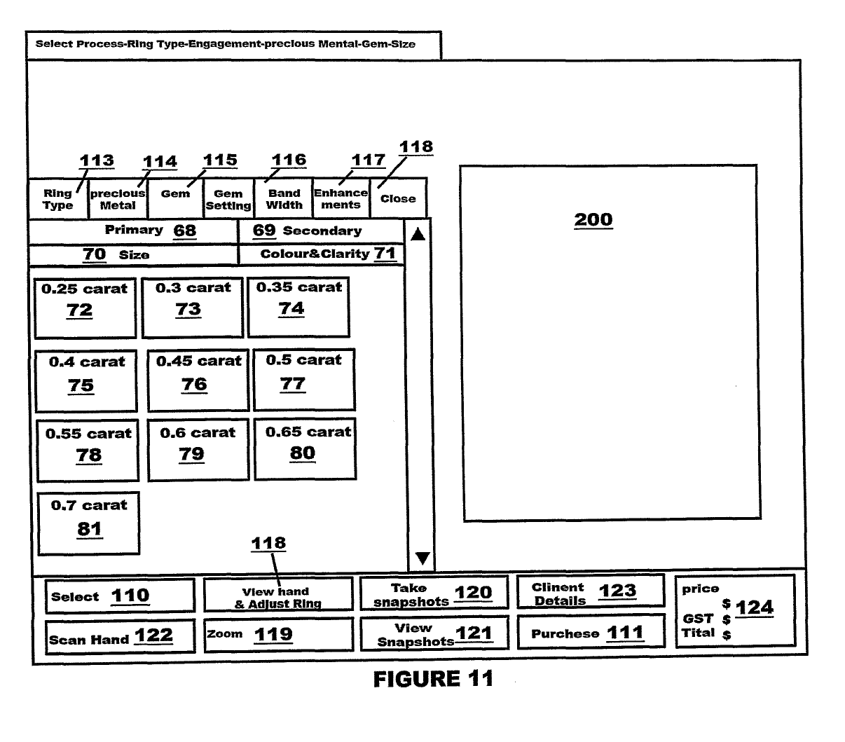

FIG. 11 depicts the screen displayed by the GUI when the pane (201) is updated after box (115) is activated, indicating that the customer is ready to select a gem.

Buttons (68) and (69) allow the operator to designate whether it is primary gem or a secondary gem which is to be selected. Those skilled in the art will understand when primary and secondary selections are appropriate. The buttons (70) and (71) allow the operator to designate whether it is the size of that gem, or gems, which is to be selected or whether it is the colour and clarity which is to be selected.

FIG. 11 shows an example where the button (70) has been activated so that buttons (72 to 81) are displayed to allow selections of the size of the gem.

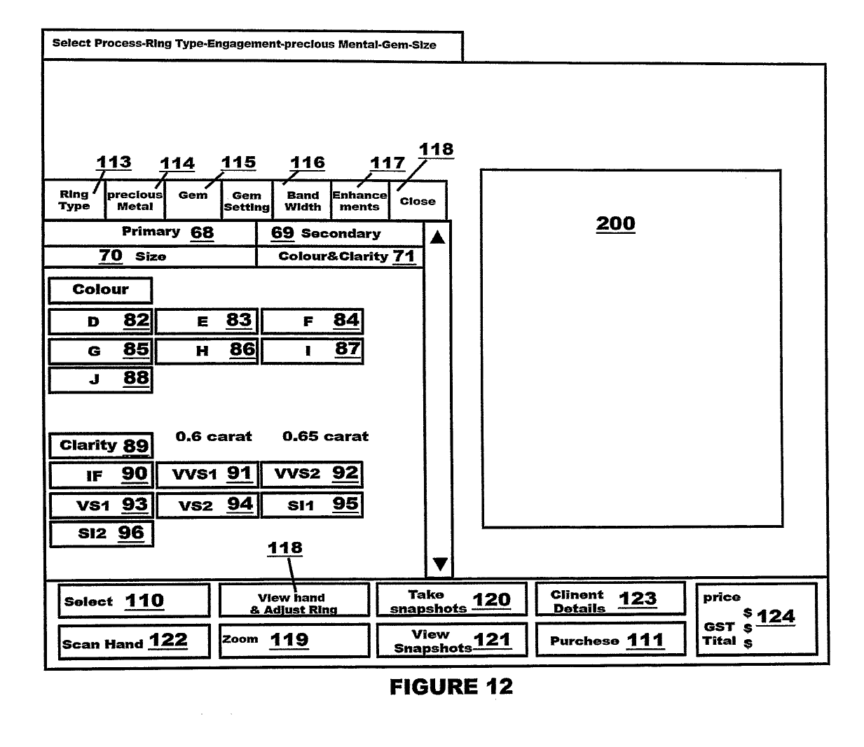

FIG. 12 shows the GUI screen (1) where the button (71) has been activated and box (201) is updated to show selections in both the colour and clarity of either the primary or secondary ring. The GUI screen (1) as shown in FIG. 12 is displayed when the buttons (115), (68) and (71) have all been successively selected. Buttons 82 to 88 depicts available choices in the selection of the colour. Boxes (90 to 96) depict available choices in the selection of the clarity of the gem. The activation of a button such as (82 to 96) will be represented by an updated generated 3-dimensional representation (not shown) appearing in pane (200). The choices made via buttons (82 to 96) will also likely have an impact on the price shown in box (124) which is updated automatically also.

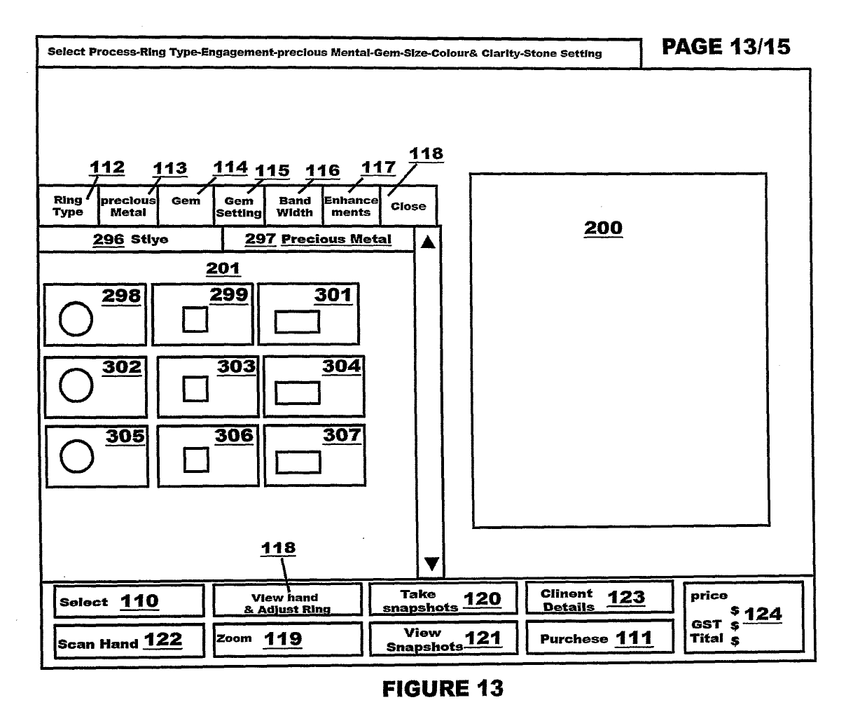

FIG. 13 shows a screen displayed by the GUI (1) when pane (201) has been updated to display choices in styles of jewellery ring gem settings when the button (116) is displayed. The boxes (298 to 307) depict various options for the selection of the gem setting in terms of style. These buttons may include pictorial representations of the jewellery ring gem settings. The button (296) allows the operator to indicate that it is the style of the gem setting which is to be selected via buttons (296 to 307). Alternatively, the button (297) allows the operator to indicate that it is the precious metal of the jewellery ring gem setting which is to be selected.

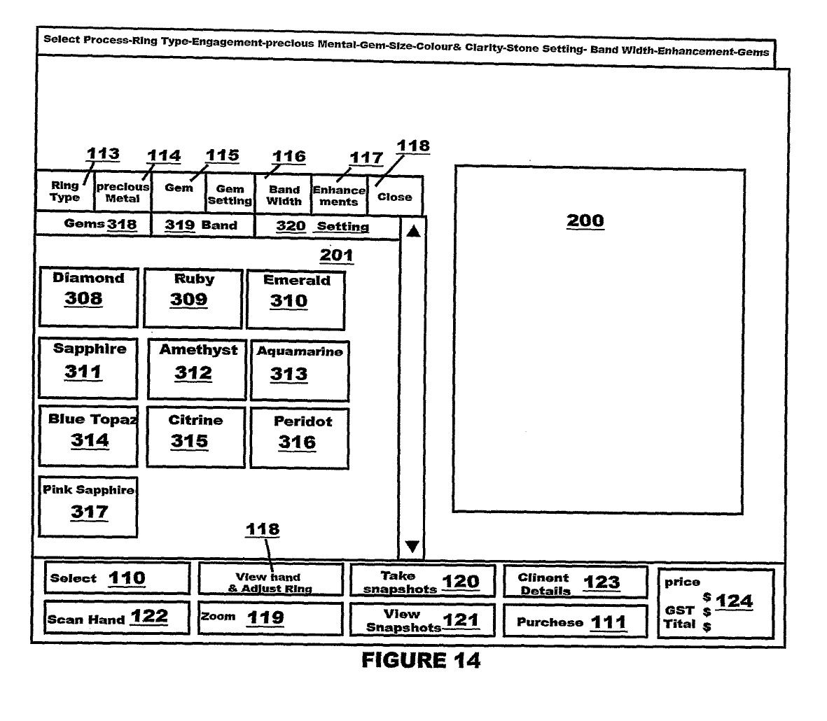

FIG. 14 depicts a similar screen in which the pane (201) has been updated to display buttons (308 to 317) representing options in the selection of the type of gem.

The pane (201) as shown in FIG. 14 is displayed when the button enhancement button (117) is activated and a gems button (318) is activated. Buttons (319) and (320) allow the pane (201) to be updated with buttons representing options in the selection of whether it is the band or setting, respectively, to which enhancement gems are to be added.

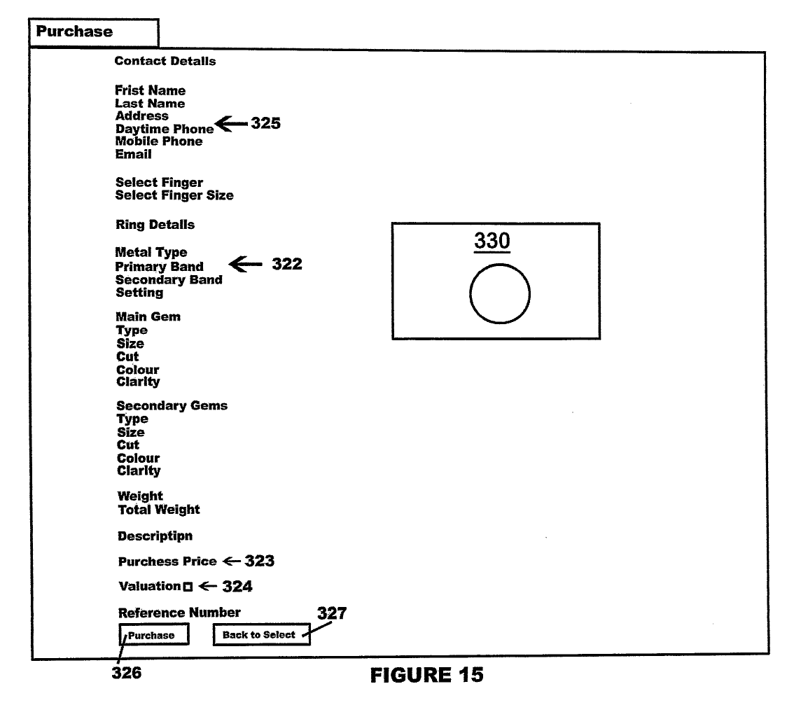

FIG. 15 shows a report generated by the GUI when the processes depicted by box (23) of FIG. 1 is activated via button (123). The report shown in FIG. 15 shows a set of fields (322) which lists all the selections made by the GUI (1). The field (323) corresponding to the information shown in box (124) corresponds to the price shown in box (124). The check box (324) indicated whether the customer would like a valuation. The fields (325) display the information gathered in the initialisation process depicted by box 3 and relating to the contact details, their selection of the designated finger for the ring and the selection of a size of a ring. Button (326) corresponds to buttons (111) and the process (11). Activation of the button (326) initiates an accounts process. The button (326) allows the operator to return to one of the screens (6 to 14) which allow selection processes depicted by box (7). Also shown on the report of FIG. 15 is a snap shot of the ring corresponding to the selections listed in the fields (322). The report shown in FIG. 15 can be printed and taken away by a customer to show to their partner for example.

The report shown in FIG. 15 can also act as a form of written quote.

Referring again to FIG. 1, the accounts process includes the steps of (328) where the operator is prompted to confirm the details of the customer initialisation process. Box (329) represents the printing of a receipt once an accounted transaction has occurred. Box (330) represents the GUI returning to its original state for another session which starts with a new initialisation process (3).

FIG. 16 depicts an overview process carried out by the preferred embodiment of the present invention.

The process (400) allows a customer to specify the characteristics of an object such as a ring and to view that object in conjunction with another object. In the example illustrated here, the objects are a ring and a hand. The ring is shown in conjunction with the hand by being showing fitted onto a finger.

The process (400) depicted in FIG. 16 allows the customer or operator to create a specification for the characteristics of the ring. The process also allows the customer or operator to see the ring which corresponds to the specification while the specification is being created. The ring is displayed in conjunction with the customer's hand so the impact of selections of various characteristics can be assessed.

The process (400) begins with step (401) in which the GUI receives a 3-dimensional representation of an object such as a customer's hand.

At step (402) the GUI displays a set of controls in the form of buttons which allow selections to be made to specify characteristics of the ring. Initially, buttons (112 to 117) are displayed although other buttons, are displayed in response to one of buttons (112 to 117) being activated.

At step (403) a control events are received by the GUI. These will typically be activation of buttons such as (23 to 40), to give examples, which identify a metal selected by the customer.

At step (404), a 3-dimensional representation of the customer's hand in conjunction with the ring specified by the selection at step (403) is generated. The 3-dimensional representation can be used to provide views of the ring on the hand from various angles.

At step (405) a display of the 3-dimensional representation of the hand and ring is displayed by the GUI. The display may include an adjustable view point and adjustable zoom.

In the preferred embodiment the steps (402 to 404) are repeated with each selection made with the controls.

In the preferred embodiment the generated 3-dimensional representation and display of that representation are updated with each selection of a characteristic. However, in alternative embodiments these may be updated only after all or some of the selections are made.

In the preferred embodiment also, the user's hand is displayed before any selections are made for characteristics of a ring. However, alternative embodiments may omit displaying the hand at this point.

Step (406) represents the end of the process, where the characteristics of the ring have been specified.

The preferred embodiment of the present invention allows the generated 3-dimensional representation of the customer's hand in conjunction with a jewellery ring allows the user to view via pane (200) a geometrically accurate and photographically accurate representation of their hand in conjunction with an accurate representation of a ring which they have specified with selections made via controls in pane (201).

As the generated 3-dimensional representation is geometrically accurate, the GUI (1) allows a customer to view interactions in the aesthetic of the dimensions of their own hand and fingers and the dimensions of various ring bands, gem setting and gems.

As the generated 3-dimensional representation of the customer's hand in conjunction with a ring they intend to purchase is also accurate in terms of the colour and texture, this allows a customer to view interactions between their skin tone and the colours of metals and gems of the jewellery ring they intend to purchase.

Aspects of the present invention have been described by way of example only and it should be appreciated that modifications and additions may be made thereto without departing from the scope thereof as defined in the appended claims.

1-48. (canceled)

49. A set of computer executable instructions stored on a computer readable medium, said instructions adapted to carry out a method including the steps of:
I. receiving a 3-dimensional representation of a first object;
II. providing a set of controls adapted to allow selections which specify characteristics of a piece of jewellery to be made;
III. receiving through said set of controls indications of events identifying said selections;
IV. generating a 3-dimensional representation of the first object combined with the piece of jewellery wherein the generated 3-dimensional representation includes a geometrical mesh representation comprising mesh elements including photographic representations of parts of the first object; and
V. providing a display of said 3-dimensional representation of the first object combined with the piece of jewellery.

50. The set of instructions of claim 49, wherein said generating the 3-dimensional representation of the first object combined with the piece of jewellery preserves the geometry of the first object and piece of jewellery.

51. The set of instructions of claim 49, wherein the method includes updating the generated 3-dimensional representation after given events identifying selections made with the controls.

52. The set of instructions of claim 49, wherein said photographic representations are displayed using at least 3 colours.

53. The set of instructions of claim 49, wherein said selections specify characteristics by selecting given components for the piece of jewellery.

54. The set of instructions of claim 49, wherein said selections specify materials for the piece of jewellery.

55. The set of instructions of claim 49, wherein said selections specify dimensions for the piece of jewellery.

56. The set of instructions of claim 55, wherein the controls are adapted to allow a user to adjust the dimensions of the piece of jewellery.

57. The set of instructions of claim 49, wherein said generated 3-dimensional representation of the first object combined with the piece of jewellery includes a representation of a given interrelationship between the first object and piece of jewellery.

58. The set of instructions of claim 57, wherein the piece of jewellery is a ring.

59. The set of instructions of claim 58, wherein the first object is a hand.

60. The set of instructions of claim 59, wherein said representation of the given interrelationship is the ring shown fitted onto a finger of the hand.

61. The set of instructions of claim 60, wherein said 3-dimensional representation of a hand combined with a ring shows a ring of a given diameter.

62. The set of instructions of claim 60, wherein the method includes providing controls adapted to allow adjustment of a position of the ring on the finger.

63. The set of instructions of claim 60, wherein said 3-dimensional representation of the hand in conjunction with a ring shows a ring of a given band width.

64. The set of instructions of claim 63, wherein the method includes providing a user control adapted to allow adjustment of the width of a band as it appears on the generated 3-dimensional representation.

65. The set of instructions of claim 49, wherein the generated 3-dimensional representation of the first object combined with the piece of jewellery is displayed from a given view point.

66. The set of instructions of claim 65, wherein the method includes providing controls adapted to allow said given view point to be reoriented.

67. The set of instructions of claim 66, wherein the generated 3-dimensional representation of the hand in conjunction with a ring is displayed with a given degree of zoom.

68. The set of instructions of claim 67, wherein the method includes providing controls to allow said given degree of zoom to be adjusted.

69. The set of instructions of claim 68, wherein the method includes capturing and storing 2-dimensional displays of said generated 3-dimensional representation of a hand in conjunction with the ring at given view points and degrees of zoom.

70. The set of instructions of claim 58, wherein generating said 3-dimensional representation includes retrieving stored 3-dimensional representations of jewellery ring components.

71. The set of instructions of claim 59, wherein the generated 3-dimensional representation of the hand combined with the ring includes at least one colour assigned to the ring band.

72. The set of instructions of claim 71, wherein the method includes providing a user control adapted to allow the selection of at least one colour assigned to the ring.

73. The set of instructions of claim 72, wherein said control adapted to allow the selection of at least one colour including a textual description of at least one metal.

74. The set of instructions of claim 73, wherein at least one colour assigned to the ring corresponds to at least one metal represented by the control.

75. The set of instructions of claim 59, wherein the method includes displaying a numerical value representing a calculated cost of the ring specified by the selections and/or adjustments.

76. The set of instructions of claim 59, wherein the method includes generating a report, said report, including details specifying any selections and/or adjustments made with said user controls.

77. The set of instructions of claim 76, wherein said report also includes a captured 2-dimensional image of the 3-dimensional representation.

78. The set of instructions of claim 76, wherein the report includes a monetary value calculated with reference to the given specification.

79. The set of instructions of claim 76, wherein the report includes details identifying the person associated with the first object.

80. The set of instructions of claim 59, wherein the user controls are adapted to allow selection of styles of jewellery ring band.

81. The set of instructions of claim 59, wherein the user control is adapted to allow selection of styles of jewellery ring gem setting.

82. The set of instructions of claim 81, wherein the user control is adapted to allow selection of at least one gem for said setting.

83. The set of instructions of claim 59, wherein the user control is adapted to allow selection of gems to be set into the band.

84. The set of instructions of claim 59, wherein the user control is adapted to allow selection of styles of jewellery ring band.

85. The set of instructions of claim 59, wherein the method includes providing a user control adapted to allow the selection of given cuts of gem.

86. The set of instructions of claim 59, wherein the method includes a control adapted to allow the selection of classifications of gems.

87. The set of instructions of claim 59, wherein the generated 3-dimensional representation includes a representation of at least one gem of a given colour.

88. The set of instructions of claim 85, wherein the method includes providing a control adapted to allow a selection of the colour of the at least one gem.

89. The set of instructions of claim 88, wherein the control provides a textual representation of a gem represented by each colour.

90. The set of instructions of claim 59, wherein the generated 3-dimensional representation includes a representation of a gem of a given size.

91. The set of instructions of claim 59, wherein the generated 3-dimensional representation includes a gem of a given cut.

92. The set of instructions of claim 59, wherein the method includes providing a control adapted to allow the selection of a weight for at least one gem.

93. The set of instructions of claim 59, wherein the method includes providing controls adapted to receive contact details of a person associated with the hand.

94. The set of instructions of claim 59, wherein the method includes providing on a screen a combination of controls adapted to:
receive contact information for a person associated with the hand;
allow the selection of a given finger of the hand; and
allow the selection of a ring size.

95. The set of instructions of claim 49, wherein the method includes providing a control adapted to initiate an apparatus to capture 3-dimensional representation of an object.
